(19) United States
(12) Patent Application Publication
(10) Pub. No.: US 2016/0356464 A1
(43) Pub. Date: Dec. 8, 2016

(54) SELF-LUMINOUS SUSPENSION LAMP

(71) Applicant: YUTOU TECHNOLOGY (HANGZHOU) CO., LTD., Hangzhou City, Zhejiang (CN)

(72) Inventor: Jiong ZHANG, Zhejiang (CN)

(21) Appl. No.: 14/764,079

(22) PCT Filed: Jun. 12, 2015
(86) PCT No.: PCT/CN2015/081407

§ 371 Date: Jul. 28, 2015

(30) Foreign Application Priority Data
Jan. 12, 2015 (CN) 201510015914.X

(51) Int. Cl. F21V 21/096; F21V 21/15; H02J 7/02; F21V 23/06

(52) U.S. Cl. CPC F21V 21/096; F21V 23/06; F21V 21/15; H02J 7/025; F21Y 2115/10

(57) ABSTRACT

The invention relates to a magnetic suspension technology field, especially to a self-luminous suspension lamp, comprising a wireless charging device, a floater in which a light-emitting device and a magnet being configured, an electromagnetic coil configured below the floater, a suspension control system connected to the electromagnetic coil. The magnetic force generated by the electromagnetic coil keeps balance to the gravity of the whole floater so that the floater is suspended. A Hall sensor is configured below the floater, the displacement of the floater will cause the feedback of the Hall sensor. The suspension controller varies the output power according to the result of the feedback of the Hall sensor, to keep the floater in a stable status in real time. Hence, the invention provides a beauty and an effect of science for the domestic illumination, and provides an enjoyment for the life.

### BACKGROUND OF THE INVENTION

1. Field of the Invention

The present disclosure relates to a magnetic suspension technology field, more specifically, to a self-luminous suspension lamp.

2. Description of the Related Art

With the development of the electronic technology, the magnetic suspension technology becomes more mature and it has ornamental value and technical value. Therefore, the magnetic suspension technology has applied to various technical fields, such as toy, gift, advertisement and industry etc.

The magnetic suspension device generally includes magnetic base and suspension body. A magnetic force generated by the repelling between an electromagnet in the magnetic base and a magnet in the suspension body keeps balance to the gravity of the suspension body, so that the suspension body remains in suspension. For example, although the lamp from marketplace is widely used due to its excellent luminous effect, if the magnetic suspension technology is applied to the lamp, the ornamental value and motion value is improved greatly.

The suspension lamp in prior art is an illumination device without electric wires. It comprises upper part and lower part: the upper part is a lampshade in which an electromagnet is configured, the lampshade is suspended on a suitable position directly; the lower part is a suspension control system in which a coil is configured. After powering on the suspension lamp, the magnetic force generated by the repelling between the electromagnet and coil offsets the gravity of the lampshade so that the upper lampshade is suspended. Then, a luminescent lamp (a lamp which illuminates) below the lampshade illuminates on the lampshade directly to make the lampshade luminous.

At present, the suspension lamp illuminates by the lower luminescent lamp illuminating the upper lampshade, an opening is configured on the lower side of the lampshade to allow the lower luminescent lamp illuminates in the lampshade. If the lampshade is a closed shape, such as round or ellipse, the light sent by the luminescent lamp can not illuminates on the lampshade evenly. Therefore, the shape and structure of the lampshade is limited, the aesthetic value of the people is reduced.

Hence, it is difficult for the skilled in the art to improve the aesthetic value of the suspension lamp.

### SUMMARY OF THE INVENTION

According to above-mentioned problem, the invention provides a self-luminous suspension lamp to address the shortcoming which the ornamental value is low due to the limitation of the shape and structure of the lampshade in the prior art.

The technical solution of the present invention is:

A self-luminous suspension lamp, comprising:

a floater, in which a light-emitting device and a magnet is configured;

a base configured below the floater, an electromagnetic coil and a suspension control system being configured in the base;

wherein, a magnetic force generated by the electromagnetic coil is balanced with a gravity of the magnet; and

the suspension control system is connected to the electromagnetic coil, and is configured to control the magnetic force of the electromagnetic coil to suspend the floater on the base.

Preferably, the self-luminous suspension lamp has a Hall sensor configured in the base; and

the Hall sensor is connected to the suspension control system.

Preferably, the self-luminous suspension lamp has a power amplifier configured in the base; and

the suspension control system is connected to the electromagnetic coil through the power amplifier, so as to control the magnetic force of the electromagnetic coil by controlling output power of the power amplifier.

Preferably, the self-luminous suspension lamp, wherein a charge coil is configured in the floater: and

the charge coil is connected to the light-emitting device and is configured to charge the light-emitting device.

Preferably, the self-luminous suspension lamp, wherein a wireless charging system is configured in the base;

the wireless charging system comprises a wireless power controller, a first power converting module connected to the wireless power controller, a full bridge converting module connected to the wireless power controller and a variable output module connected to the wireless power controller:

wherein, the full bridge converting module is connected to the variable output module and the electromagnetic coil.

Preferably, the self-luminous suspension lamp further comprises a power supply; and

the power supply is connected to the wireless power controller through the first power converting module.

Preferably, the self-luminous suspension lamp, wherein a second power converting module is configured in the base; and

the power supply is connected to the suspension control system through the second power converting module.

Preferably, the self-luminous suspension lamp, wherein an output voltage of the power supply is 12V.

Preferably, the self-luminous suspension lamp, wherein the light-emitting device is a light-emitting diode (LED) lamp.

The above-mentioned technical solution has the following benefits:

The present invention discloses a self-luminous suspension lamp comprising a wireless charging device, a floater in which a light-emitting device and a magnet being configured, an electromagnetic coil configured below the floater, a suspension control system connected to the electromagnetic coil. In the present invention, the magnet is configured in the floater, the magnetic force generated by the electromagnetic coil after powering on is balanced with the gravity of the whole floater (including light-emitting device and magnet) so that the floater is suspended. A Hall sensor is configured below the floater, the displacement of the floater will cause the feedback of the Hall sensor. Further, the suspension controller varies the output power according to the result of the feedback of the Hall sensor, to keep the floater in a stable status in real time. Hence, the invention provides a beauty and an effect of science for the domestic illumination, and provides an enjoyment for the life. Meanwhile, the structure of the invention is simple, and is easy to manufacture, therefore it has wide application prospect.

### BRIEF DESCRIPTIONS OF THE DRAWINGS

Referring to the accompanying drawings, the description made by the unlimited embodiments, the disclosure and the feature, outline and advantage thereof will be more obvious. The same signs in all drawings indicate the same portions and they are not drawn in proportion intentionally. It illustrates the meaning of the invention.

FIG. 1 shows the structure schematic view of the self-luminous suspension lamp according to the present invention.

### DETAILED DESCRIPTIONS

The core concept of the invention is as follows: set a magnet and a light-emitting device in the floater, balance the magnetic force generated by the electromagnetic coil after powering on with the gravity of the whole floater (including light-emitting device and magnet) so that the floater is suspended. Set a Hall sensor below the floater, the displacement of the floater will cause the feedback of the Hall sensor. Further, the suspension controller varies the output power according to the result of the feedback of the Hall sensor, to keep the floater in a stable status in real time.

The present disclosure will now be described more fully hereinafter with reference to the accompanying drawings, in which exemplary embodiments of the invention are shown. This invention may, however, be embodied in many different forms and should not be construed as limited to the embodiments set forth herein.

To address the shortcoming which the ornamental value is low due to the limitation of the shape and structure of the lampshade in the prior art, the invention provides a self-luminous suspension lamp.

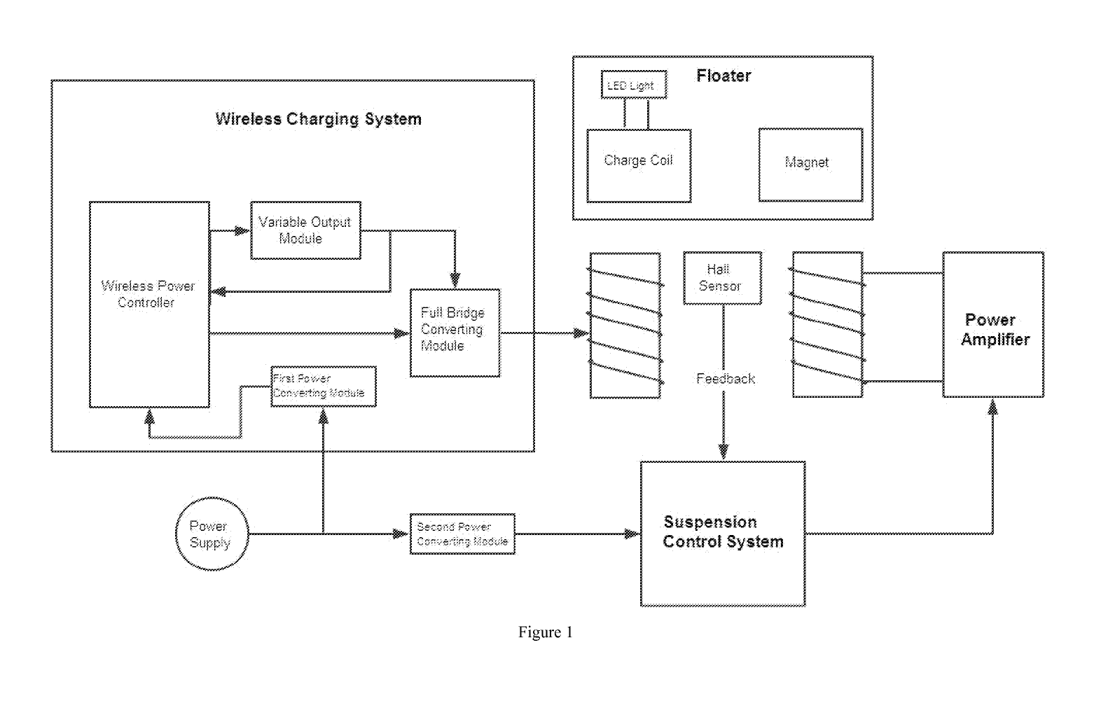

Referring to FIG. 1, the self-luminous suspension lamp comprises a floater and a base configured below the floater, an electromagnetic coil configured in the base and a suspension control system connected to the electromagnetic coil.

According to one embodiment of the present invention, a light-emitting device and a magnet are configured in the floater, the magnet generates an opposite magnetic field to the electromagnetic coil during the operation of the suspension lamp, the magnet suffers a repelling force in an upward direction, the repelling force generated by the electromagnetic coil is balanced with the gravity of the whole floater (including light-emitting device and magnet) so that the floater is suspended. Preferably, the light-emitting device is a LED light.

Preferably, in an embodiment of the present invention, there are two electromagnetic coils, a Hall sensor is configured between two electromagnetic coils and is configured in the base. The Hall sensor is connected to the suspension control system. When the floater changes its position, the Hall sensor can detect the feedback signal which reflects the variation of the magnetic field intensity of the electromagnet configured in the floater, and sends the feedback signal to the suspension control system. The suspension control system varies the magnetic force generated by the magnetic field of the electromagnetic coil in real time, so that the rebelling force of the floater offsets the gravity of the floater, and the floater is suspended in an optimal suspension position. The suspension control system is also connected to a power amplifier (the suspension control system varies the magnetic field intensity of the electromagnetic coil by adjusting output power of the power amplifier), the power amplifier is connected to the electromagnetic coil so as to vary the magnetic field generated by the electromagnetic coil in real time.

When the LED light emits light beam on the floater, it is possible to make the emitting beam of the LED light distribute on the floater evenly, so as to increase the scope of design for the structure and shape of the suspension lamp. A charge coil, configured in the floater, provides the power to the LED. The magnetic field generated by the charge coil in the floater is varied by varying the magnetic field of the electromagnetic coil, so that the charge coil generates the induced electromotive force to drive the LED light to be self-luminous continually.

In the self-luminous suspension lamp, a wireless charging system is configured in the base. The wireless charging system is connected to one of the electromagnetic coils, the suspension control system is connected to the other. The wireless charging system comprises a wireless power controller, a first power converting module connected to the wireless power controller, a full bridge converting module connected to the wireless power controller and a variable output module connected to the wireless power controller, wherein the full bridge converting module is connected to the variable output module. To provide the power to the electrical energy of the electromagnetic coil or the variation of the electric field continually, a further power supply (such as the voltage is 12V or other output voltage values) is required. The power supply is connected to the first power converting module, and is connected to the suspension control system through the second power converting module. Preferably, the second power converting module is configured in the base. On the one hand, when the power supply outputs the voltage, the first power converting module decreases the voltage (such as 3V) and transmits the decreased voltage to the wireless power controller. The wireless power controller adjusts the output power directly or by the variable output module, the power is then provided to the full bridge converting module. The full bridge converting module is connected to the electromagnetic coil. The full bridge converting module receives the corresponding power, and outputs the alternating voltage to form the alternating magnetic field in the electromagnetic coil. Because the magnetic field in the electromagnetic coil is varied, the charge coil in the corresponding floater generates the induced electromotive force to drive the LED light to be self-luminous continually. On the other hand, when the power supply outputs the voltage, the first power converting module decreases the voltage (such as 3V) and transmits the decreased voltage to the wireless power controller. The wireless power controller varies the magnetic field by the power amplifier so that the floater is suspended stably.

Meanwhile, the self-luminous suspension lamp provided by the invention illuminates the lamp by internal LED light, thus the whole lamp is shine. The lamp can be round or other shapes. The suspension lamp placed in home not only can be a illumination, but also is a beautiful ornament. For example, in an optional solution, a self-luminous suspension tellurion according to the invention acts as a floater suspended on a base. At present, the present suspension tellurion can not be luminous. It can be shine by reflecting the light emitted by external light, therefore only local map illuminated can be seen in the tellurion. By adopting the technology according to the invention, the whole tellurion is luminous and any point of it can be seen, this is not achieved by the prior art.

In conclusion, the present invention discloses a self-luminous suspension lamp comprising a wireless charging device, a floater in which a light-emitting device and a magnet being configured, an electromagnetic coil configured below the floater, a suspension control system connected to the electromagnetic coil. In the present invention, the magnet is configured in the floater, the magnetic force generated by the electromagnetic coil after powering on is balanced with the gravity of the whole floater so that the floater is suspended. A Hall sensor is configured below the floater, the displacement of the floater will cause the feedback of the Hall sensor. Further, the suspension controller varies the output power according to the result of the feedback of the Hall sensor, to keep the floater in a stable status in real time. Hence, the invention provides a beauty and an effect of science for the domestic illumination, and provides an enjoyment for the life. Meanwhile, the structure of the invention is simple, and is easy to manufacture, therefore it has wide application prospect.

The people skilled in art should be understood that the various embodiments can be implemented by combining the prior art and above-mentioned embodiments, and it is not described hereafter. The various embodiments do not impact the essential content of the invention, and it is not described hereafter.

While the present disclosure has been described in connection with certain exemplary embodiments, it is to be understood that the invention is not limited to the disclosed embodiments, the device and structure, which are not specifically described, should be understood as the common manner in the art to be implemented; any people skilled in the art can make possible changes and modifications, or equivalents thereof for the technical solution of the invention according to the above method without falling out of the scope of the invention. Therefore, the various modifications and equivalent arrangements without departing away from the technical solution of the invention, are included within the spirit and the scope of the technical solution of the invention.

What is claimed is:

1. A self-luminous suspension lamp, comprising:
a floater, in which a light-emitting device and a magnet is configured;
a base configured below the floater, an electromagnetic coil and a suspension control system being configured in the base;
wherein, a magnetic force generated by the electromagnetic coil is balanced with a gravity of the magnet; and
the suspension control system is connected to the electromagnetic coil, and is configured to control the magnetic force of the electromagnetic coil to suspend the floater on the base.

2. The self-luminous suspension lamp as claimed in claim 1, wherein a Hall sensor is configured in the base; and
the Hall sensor is connected to the suspension control system.

3. The self-luminous suspension lamp as claimed in claim 1, wherein a power amplifier is configured in the base; and
the suspension control system is connected to the electromagnetic coil through the power amplifier, so as to control the magnetic force of the electromagnetic coil by adjusting output power of the power amplifier.

4. The self-luminous suspension lamp as claimed in claim 1, wherein a charge coil is configured in the floater; and
the charge coil is connected to the light-emitting device and is configured to charge the light-emitting device.

5. The self-luminous suspension lamp as claimed in claim 1, wherein a wireless charging system is configured in the base;
the wireless charging system comprises a wireless power controller, a first power converting module connected to the wireless power controller, a full bridge converting module connected to the wireless power controller and a variable output module connected to the wireless power controller;
wherein, the full bridge converting module is connected to the variable output module and the electromagnetic coil.

6. The self-luminous suspension lamp as claimed in claim 5, wherein further comprising a power supply; and
the power supply is connected to the wireless power controller through the first power converting module.

7. The self-luminous suspension lamp as claimed in claim 6, wherein a second power converting module is configured in the base; and
the power supply is connected to the suspension control system through the second power converting module.

8. The self-luminous suspension lamp as claimed in claim 6, wherein an output voltage of the power supply is 12V.

9. The self-luminous suspension lamp as claimed in claim 1, wherein the light-emitting device is a light-emitting diode (LED) lamp.
